(19) United States
(12) Patent Application Publication
(10) Pub. No.: US 2006/0030340 A1
(43) Pub. Date: Feb. 9, 2006

(54) Method and system for determining a destination in a mobile radio

(75) Inventors: Jyh-Han Lin, Parkland, FL (US); Biren R. Patel, Coral Springs, FL (US); Ronald R. Smith, Coral Springs, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/912,597

(22) Filed: Aug. 5, 2004

(51) Int. Cl. H04Q 7/20

(52) U.S. Cl. 455/457; 455/414.1; 455/456.2

(57) ABSTRACT

A method (70) and system (11) of determining a destination can include obtaining (72) at least one identifier among a phone number, a dispatch identifier, a mobile internet protocol address, an instant messaging user identifier, an e-mail address, or other identifier having mobility management information, mapping (74) the at least one identifier to an approximate physical location, and selectively retrieving (76) the approximate physical location corresponding to the at least one identifier. For example, mapping can be done by mapping the phone number to a physical address provided by white pages or yellow pages from on-line phonebooks or by mapping to location services (such as GPS or network based locating services) available at a cellular phone, dispatch radio, or wireless internet protocol device. Mapping can include mapping at least one among the IM user identifier or the e-mail address to a PSTN, a dispatch identifier or an internet protocol address.

### FIELD OF THE INVENTION

This invention relates generally to user interfaces, and more particularly to determining a physical location affiliated with an identifier used in a mobile phone.

### BACKGROUND OF THE INVENTION

Location applications like navigation applications are some of the most compelling Java applications in iDEN Java phones and will likely be introduced to other cellular phones. Navigation applications such as TeleNav and ViaMoto use landmarks and addresses to identify destinations and provide directions to such destinations. In such systems, end users enter destinations at web sites before a trip, or enter destination data on a handset, or call a service center. In each instance, additional initial steps might be taken that are not necessarily intuitive, friendly, or most efficient for users

No existing system utilizes conventional identifiers that can be mapped to physical addresses to provide a more user friendlier means for destination identification. In existing systems, it might be cumbersome for some users to enter a street address in a mobile environment (or otherwise), whereas other information might be readily available to achieve a similar end result. In some instances, existing navigation systems require the use of a live dispatcher or a customer service representative to obtain such information which greatly adds to the cost of such a system. Other systems might operate in response to receiving a call rather than by an action initiated by a user. Once again, no existing system allows a user to request destination information in a more user friendly and flexible manner without limitations requiring the receipt of a call or a call into a customer service representative.

### SUMMARY OF THE INVENTION

In a first embodiment of the present invention, a method of determining a destination using a mobile radio can include the steps of obtaining at least one identifier among a phone number, a dispatch identifier, a mobile internet protocol address, an instant messaging (IM) user identifier, an electronic mail address, a group communication identifier, or other identifier having mobility management information, mapping the at least one identifier to an approximate physical location, and selectively retrieving the approximate physical location corresponding to the at least one identifier using a user interface on the mobile radio. The step of mapping can be done in various ways. For example, mapping a phone number can be done by mapping the phone number to a physical address provided by white pages or yellow pages from on-line phonebooks. Alternatively, a phone number can be mapped to location services available at a cellular phone, dispatch radio, or wireless internet protocol device. The location services can be global positioning services (GPS), network based locating services, or other location services that might become available in the future. In yet another alternative, the step of mapping can include the step of mapping at least one among the instant messaging user identifier or the electronic mail address to a public switched telephone network (PSTN), a dispatch identifier or an internet protocol address. The method can further include the step of presenting to the end user an option of following an originating number or a forwarding number when the phone number being called is using a call forwarding service. Note, the user interface can be at least one among a menu displayed on a screen using a softkey for selection of the at least one identifier or a dedicated key on a keypad of the mobile phone. Of course, other user interfaces are contemplated herein including hands-free voice controlled user interfaces.

In a second embodiment of the present invention, a system for determining a destination using a mobile radio can include a transceiver and a processor coupled to the transceiver. The processor can be programmed to obtain at least one identifier among a phone number, a dispatch identifier, a mobile internet protocol address, an instant messaging user identifier, an electronic mail address, a group communication identifier, or other identifier having mobility management information, map the at least one identifier to an approximate physical location, and selectively retrieve the approximate physical location for the at least one identifier by using a user interface on the mobile radio. The processor can be further programmed to perform the mapping function by mapping the phone number to a white-pages or a yellow-pages phonebook to obtain the approximate physical location. Alternatively, the processor can be programmed to map the phone number to location services available at one among a cellular phone, a dispatch radio, or a wireless Internet Protocol device. The location services is selected among global positioning services and network based locating services. The processor can further be programmed to map at least one among the instant messaging user identifier or the electronic mail address to a public switched telephone network, a dispatch identifier or an internet protocol address. The processor can also be programmed to present to the end user an option of following an originating number or a forwarding number when the phone number being called is using a call forwarding service. Note, the user interface can be among a menu displayed on a screen using a softkey for selection of the at least one identifier or a dedicated key on a keypad of the mobile phone. As noted previously, the user interface can also come in other forms.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a communication device and system using a method and system for determining a destination in accordance with an embodiment of the present invention.

FIG. 2 is a chart illustrating a variety of identifiers and their respective location mapping methods in accordance with an embodiment of the present invention.

FIG. 3 is a flow chart illustrating a method for determining a destination in accordance with an embodiment of the present invention

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

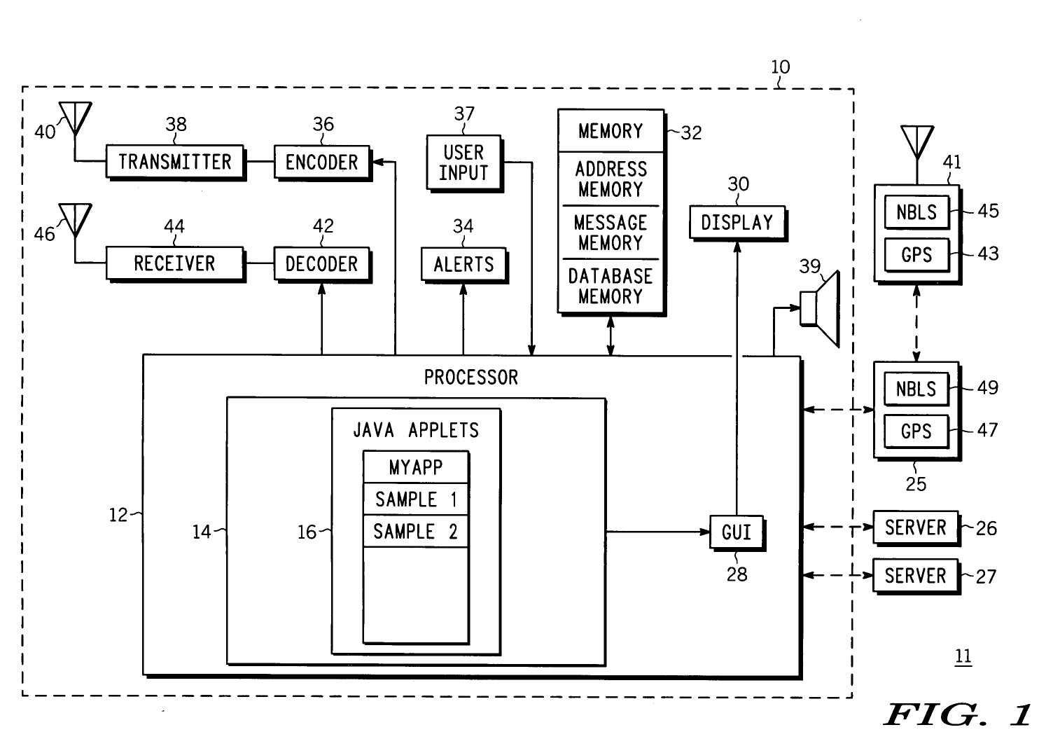

Referring to FIG. 1, a block diagram of a system 11 and a portable communication device 10 can comprise a conventional cellular phone, a two-way trunked radio, a combination cellular phone and personal digital assistant, a smart phone, a home cordless phone, a satellite phone or even a wired phone having a display and a user interface in accordance with embodiments of the present invention. In this particular embodiment, the portable communication device 10 can include an encoder 36, transmitter 38 and antenna 40 for encoding and transmitting information as well as an antenna 46, receiver 44 and decoder 42 for receiving and decoding information sent to the portable communication device 10. The device 10 can further include an alert 34, memory 32, a user input device 37 (such as a keyboard, mouse, voice recognition program, etc.), a speaker or annunciator 39, and a display 30 for at least displaying a graphical user interface (GUI) 28 as will be further detailed below. The device 10 can further include a processor or controller 12 coupled to the display 30, the encoder 36, the decoder 42, the alert 34, the user input 37 and the memory 32. The memory 32 can include address memory, message memory, and memory for database information or for applications such as JAVA applications and the various modes of communication associated with such applications. Such applications can reside in external memory (32) or in internal memory 16 within a portion 14 of the processor 12 as shown. The memory (either 32 or 16) can include a database or one or more look-up tables that can correlate a selected portion of content (such as an identifier such as a phone number, a dispatch identifier, a mobile internet protocol address, an instant messaging user identifier, an electronic mail address, a group communication identifier, or other identifier having mobility management information) from the GUI 28 with one or more applications. A local database such as a local phonebook can be mapped to phone numbers with addresses stored in a local phonebook if needed. The communication device 10 can also or alternatively communicate, connect and otherwise retrieve or download (or upload) information (if needed) from one or more remote servers 25, 26, and 27 that can contain mapped information (physical location addresses) such as a web page having white pages or yellow pages that contain physical addresses. If an Applet or J2ME MIDlet is used, then the new information can be retrieved from the address or URL provided. In one embodiment, the application can be used as the means for retrieving location information from another mobile or fixed communication device using a Java-based application although other applications are contemplated for use within the scope of the present invention. For example, the user of communication device 10 can use the phone number of another communication device 41 to retrieve a physical location of the communication device 41 using information gathered from GPS information 43 or networked based location services 45 at the communication device. Likewise, similar GPS information 47 or network based location services information 49 can be retrieved from a server linked to the communication device 41.

Java enabled mobile handsets for example can contain many types of Java applications, including the ones that connect with specialized servers like a navigation system. A JAVA application can have multiple modes of communication. For example, such application can connect with an internet server via an any number of IP addresses corresponding to addresses on servers or with a voice-enabled server via a interconnect number or connect with a voice-enabled server via a direct-connect (dispatch or PTT) number. These servers are addressable using IP addresses or even phone (or interconnect) or dispatch (or direct-connect) numbers. These addresses are usually provisioned during application installation and downloading. In cases where multiple servers are available, the user may be required to select one of the servers available. Again, each application can have a phonebook-like entry, with the ability to provide multiple server IP addresses, interconnect numbers, and/or dispatch (PTT or private call ID or direct-connect) numbers. Also note that the servers described above can come in the form of a mobile device which would facilitate peer-to-peer communications and applications.

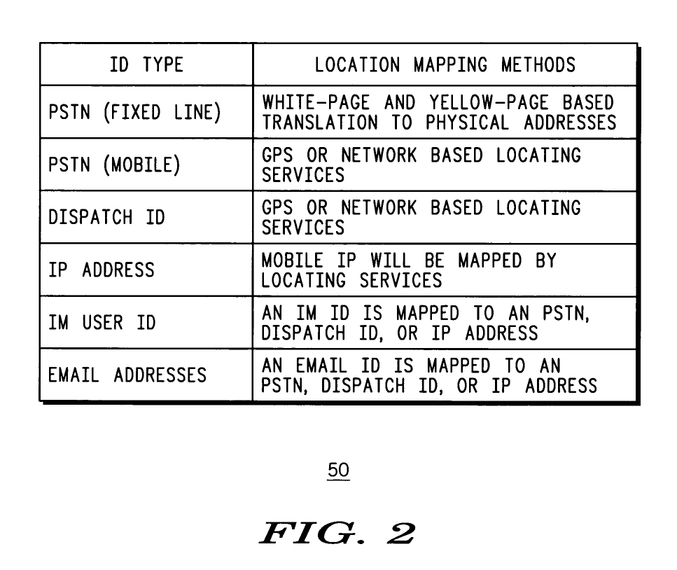

As noted above, an embodiment in the form of a navigation application can use identifiers such as phone numbers, dispatch ID, mobile IP addresses, and other digital identifications with mobility management to identify a destination. The phone number, dispatch ID, and IP addresses for example, can be found in the user phone books. Phone numbers for destinations can be easily found in yellow pages using a wireless web browser. For fixed line phone or mobile phone using call forwarding service, the end user can be presented with the option to follow the original number or the number being forwarded to. Mobile email ID can be used as well as long as it has mobility support. The chart 50 of FIG. 2 summarizes the different identifiers and the respective location mapping methods that can be used to obtain a physical location address.

Further note that navigation to a physical address by identifier can be integrated into most, if not all, of the aspects of a user interface. For example, a communication device phone book, browser yellow and white pages, recent call list, hot call list, messages, instant messaging, a group communication list, and Caller ID. In one example, if a user selects a group identifier, several choices can be provided t the user in the form of group members. More specifically, an email distribution list can be expanded to provide multiple e-mail addresses or a group call list can provide identifiers for each of the members in the group. Further note that the navigation feature can be accessed in numerous ways using a user input 37 including a menu or soft key or a dedicated button on a phone keypad. The user input in this regard could also be a microphone using voice commands to retrieve the desired information. Navigation by identifier in this regard can be extended to picture identification, fingerprint, or voice imprint identification. The fixed end can provide matching services and locating services for picture ID or other identification means such as biometric information. Services like this can be integrated with homeland security applications.

Such a concept is a powerful tool that could be abused in the wrong hands and potentially create privacy concerns. To address privacy concerns of private individuals, particularly with mobile phones, a target user's phone can prompt the target user when the target user's phone is queried and allow the target user to authenticate the requesting party, and respond with a present position of the target user using one of the location methods previously discussed.

As a result of a system or method discussed above, several embodiments in accordance with the present invention can provide almost seamless destination identification and an easier means for an end user to obtain destination location information by entering an ID rather than a detailed address. Such a system can also easily integrate into existing phone user interfaces and applications. A dedicated button for such purpose can also add further ease of use.

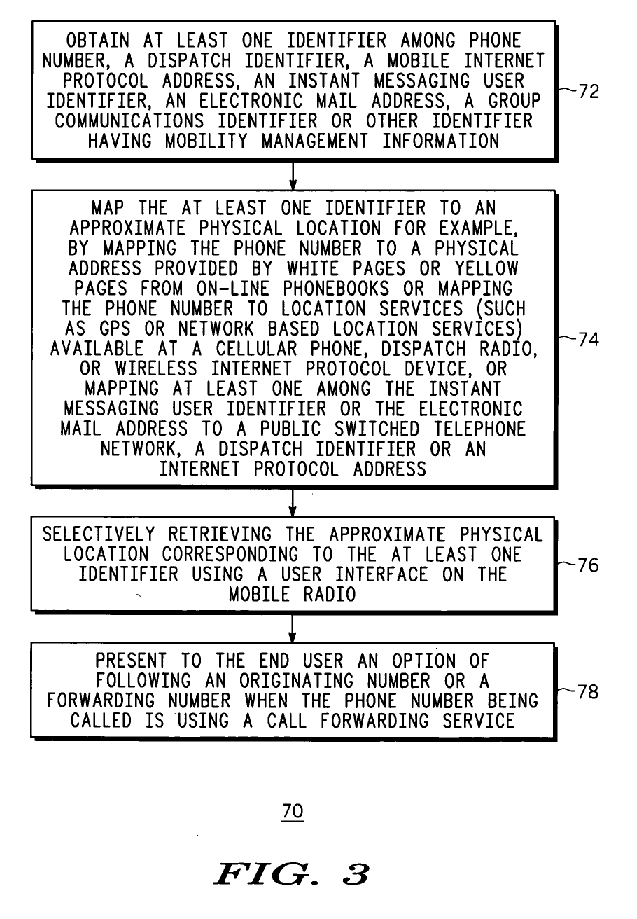

Referring to FIG. 3, a flow chart illustrating a method 70 of determining a destination using a mobile radio can include the step 72 of obtaining at least one identifier among a phone number, a dispatch identifier, a mobile internet protocol address, an instant messaging user identifier, an electronic mail address, or other identifier having mobility management information and the step 74 of mapping the at least one identifier to an approximate physical location for example, by mapping the phone number to a physical address provided by white pages or yellow pages from on-line phonebooks or mapping the phone number to location services (such as GPS or network based location services) available at a cellular phone, dispatch radio, or wireless internet protocol device, or mapping at least one among the instant messaging user identifier or the electronic mail address to a public switched telephone network, a dispatch identifier or an internet protocol address. The method 70 can further include the step 76 of selectively retrieving the approximate physical location corresponding to the at least one identifier using a user interface on the mobile radio. Optionally, the method 70 can also present to the end user at step 78 an option of following an originating number or a forwarding number when the phone number being called is using a call forwarding service

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of determining a destination using a mobile radio, comprising the steps of:
obtaining at least one identifier among a phone number, a dispatch identifier, a mobile internet protocol address, an instant messaging user identifier, an electronic mail address, a group communication identifier, or other identifier having mobility management information;
mapping the at least one identifier to an approximate physical location; and
selectively retrieving the approximate physical location corresponding to the at least one identifier using a user interface on the mobile radio.

2. The method of claim 1, wherein the method further comprises the step of mapping the phone number to a white-pages or yellow-pages phonebook to obtain the approximate physical location.

3. The method of claim 1, wherein the method further comprises the step of mapping the phone number to location services available at one among a cellular phone, a dispatch radio, or a wireless Internet Protocol device.

4. The method of claim 3, wherein the location services is selected among global positioning services and network based locating services.

5. The method of claim 1, wherein the method further comprises the step of mapping at least one among the instant messaging user identifier or the electronic mail address to a public switched telephone network, a dispatch identifier or an internet protocol address.

6. The method of claim 1, wherein the method further comprises the step of presenting to the end user an option of following an originating number or a forwarding number when the phone number being called is using a call forwarding service.

7. The method of claim 1, wherein the user interface comprises at least one among a menu displayed on a screen using a softkey for selection of the at least one identifier or a dedicated key on a keypad of the mobile phone.

8. A system for determining a destination using a mobile radio, comprising:
a transceiver; and
a processor coupled to the transceiver, wherein the processor is programmed to:
obtain at least one identifier among a phone number, a dispatch identifier, a mobile internet protocol address, an instant messaging user identifier, an electronic mail address, a group communication identifier, or other identifier having mobility management information;
map the at least one identifier to an approximate physical location; and
selectively retrieve the approximate physical location for the at least one identifier by using a user interface on the mobile radio.

9. The system of claim 8, wherein the processor is further programmed to map the phone number to a white-pages or a yellow-pages phonebook to obtain the approximate physical location.

10. The system of claim 8, wherein the processor is further programmed to map the phone number to location services available at one among a cellular phone, a dispatch radio, or a wireless Internet Protocol device.

11. The system of claim 10, wherein the location services is selected among global positioning services and network based locating services.

12. The system of claim 8, wherein the processor is further programmed to map at least one among the instant messaging user identifier or the electronic mail address to a public switched telephone network, a dispatch identifier or an internet protocol address.

13. The system of claim 8, wherein the processor is further programmed to present to the end user an option of following an originating number or a forwarding number when the phone number being called is using a call forwarding service.

14. The system of claim 8, wherein the user interface comprises at least one among a menu displayed on a screen using a softkey for selection of the at least one identifier or a dedicated key on a keypad of the mobile phone.

15. A machine readable storage, having stored thereon a computer program having a plurality of code sections executable by a machine for causing the machine to perform the steps of:
obtaining at least one identifier among a phone number, a dispatch identifier, a mobile internet protocol address, an instant messaging user identifier, an electronic mail address, a group communication identifier, or other identifier having mobility management information;
mapping the at least one identifier to an approximate physical location; and
selectively retrieving the approximate physical location for the at least one identifier by using a user interface on a mobile radio.

16. The machine readable storage of claim 15, wherein the computer program further has a plurality of code sections executable by the machine for causing the machine to perform the step of mapping the phone number to a white-pages or yellow-pages phonebook to obtain the approximate physical location.

17. The machine readable storage of claim 15, wherein the computer program further has a plurality of code sections executable by the machine for causing the machine to perform the step of mapping the phone number to location services available at one among a cellular phone, a dispatch radio, or a wireless Internet Protocol device.

18. The machine readable storage of claim 15, wherein the computer program further has a plurality of code sections executable by the machine for causing the machine to perform the step of mapping at least one among the instant messaging user identifier or the electronic mail address to a public switched telephone network, a dispatch identifier or an internet protocol address.

19. The machine readable storage of claim 15, wherein the computer program further has a plurality of code sections executable by the machine for causing the machine to perform the step of presenting to the end user an option of following an originating number or a forwarding number when the phone number being called is using a call forwarding service.
